(19) United States
(12) Patent Application Publication
(10) Pub. No.: US 2017/0324102 A1
(43) Pub. Date: Nov. 9, 2017

(54) FUEL CELL SYSTEM

(71) Applicant: Intelligent Energy Limited, Loughborough (GB)

(72) Inventors: Gareth David John Nash, Loughborough (GB); David Edgar, Loughborough (GB); Emma Caroline Louise Burrow, Loughborough (GB)

(73) Assignee: Intelligent Energy Limited, Loughborough (GB)

(21) Appl. No.: 15/533,236

(22) PCT Filed: Dec. 3, 2015
(86) PCT No.: PCT/GB2015/053693

§ 371 Date: Jun. 5, 2017

(30) Foreign Application Priority Data
Dec. 5, 2014 (GB) 1421699.8

(51) Int. Cl. H01M 8/04223; H01M 8/04664; H01M 8/04537; H01M 8/04746; H01M 8/04119

(52) U.S. Cl. CPC H01M 8/04231; H01M 8/04753; H01M 8/04179; H01M 8/04552; H01M 8/04686

(57) ABSTRACT

A fuel cell system comprises a fuel cell having an anode flow path extending through the fuel cell between an anode inlet and an anode outlet, and a cathode flow path extending through the fuel cell between a cathode inlet and a cathode outlet. An anode purge valve is coupled to the anode outlet and has an outlet coupled to the cathode inlet. A purge valve controller is configured to effect a purge cycle by opening and closing the anode purge valve and to monitor a fuel cell voltage profile during the purge cycle to determine an operational state of the anode purge valve. A fuel cell voltage drop during a period following a command signal instructing opening of the anode purge valve is used to indicate successful start of a purge cycle. A fuel cell voltage rise during a period following a command signal instructing closing of the anode purge valve is used to indicate a successful end to a purge cycle.

The present invention relates to fuel cells and in particular, though not exclusively, to proton-exchange membrane type fuel cells in which fuel such as hydrogen is supplied to the anode side of the fuel cell, an oxidant such as oxygen/air is supplied to the cathode side of the fuel cell and a by-product such as water is produced at and removed from the cathode side of the fuel cell.

Such fuel cells typically comprise a proton exchange membrane (PEM) sandwiched between two porous electrodes, together comprising a membrane-electrode assembly (MEA). The MEA itself is conventionally sandwiched between: (i) a cathode diffusion structure having a first face adjacent to the cathode face of the MEA and (ii) an anode diffusion structure having a first face adjacent the anode face of the MEA. The second face of the anode diffusion structure contacts an anode fluid flow field plate for current collection and for distributing hydrogen to the second face of the anode diffusion structure. The second face of the cathode diffusion structure contacts a cathode fluid flow field plate for current collection, for distributing oxygen to the second face of the cathode diffusion structure, and for extracting excess water from the MEA. A plurality of such fuel cells are conventionally layered in a series configuration to form a fuel cell stack.

In practice, it is found that water, in both liquid and vapour form (and potentially other contaminants) can build up on the anode side of the fuel cells, e.g. by a small transfer of water through the MEA from the cathode side of the fuel cell. It is common practice to periodically perform a purge of the anode to displace the accumulated water and other contaminants. In the absence of an available supply of inert gas to perform such a purge on the anode side, it is known to perform the purge by using a purge flow of hydrogen though the anode. The purge flow represents a greater flow of hydrogen through the anode flow path than is being consumed by the electrochemical reaction taking place at the MEA, so that excess hydrogen is discharged from an anode outlet, carrying with it unwanted contaminants including water and water vapour. The purge flow may be controlled by a purge valve downstream of the anode outlet.

To minimise wastage of unreacted hydrogen used during purge, it is desirable to carefully control the duration and periodicity of hydrogen purges. Ideally, hydrogen purges would be performed only when required, and only for a duration long enough to achieve the objective of sufficient purging of contaminants from the anode flow path.

It is an object of the present invention to provide an alternative and/or improved technique for monitoring and/or controlling the operation of a purge valve in a fuel cell system.

According to one aspect, the present invention provides a fuel cell system comprising:
a fuel cell having an anode flow path extending through the fuel cell between an anode inlet and an anode outlet, and a cathode flow path extending through the fuel cell between a cathode inlet and a cathode outlet;
an anode purge valve coupled to the anode outlet, the anode purge valve having an outlet coupled to the cathode inlet;
a purge valve controller configured to effect a purge cycle by opening and closing the anode purge valve and to monitor a fuel cell voltage profile during the purge cycle to determine an operational state of the anode purge valve.

The purge valve controller may be configured to determine a fuel cell voltage drop during a period following a command signal instructing opening of the anode purge valve. The purge valve controller may be configured to determine a fuel cell voltage rise during a period following a command signal instructing closing of the anode purge valve. The purge valve controller may be configured to determine a purge valve error condition if the fuel cell voltage drop fails to exceed a predetermined amount. The purge valve controller may be configured to determine a purge valve error condition if the fuel cell voltage rise fails to exceed a predetermined amount. The controller may be configured to shut down hydrogen flow to the anode inlet in the event of a purge valve error condition. The controller may be configured to increase drive voltage and/or current to the anode purge valve in the event of a purge valve failing to operate sufficiently.

The controller may be configured to recalibrate one or both of:
an opening drive voltage and/or current set point for the anode purge valve for initiating a purge cycle according to the outcome of the increased drive voltage and/or current; and
a closing drive voltage and/or current set point for the anode purge valve for ending a purge cycle according to the outcome of the increased drive voltage and/or current.

The purge valve controller may be configured to monitor a fuel cell system temperature rise following a command signal instructing opening of the anode purge valve. The purge valve controller may be configured to determine a purge valve error condition if the temperature rise exceeds a predetermined amount. The purge valve controller may be configured to monitor a fuel cell system temperature following a command signal instructing closing of the anode purge valve. The purge valve controller may be configured to determine a purge valve error condition if the temperature fails to fall by a predetermined amount with a predetermined time following the command signal instructing closing of the anode purge valve.

According to another aspect, the invention provides a method of operating a fuel cell system comprising:
initiating a purge cycle by providing opening and closing command signals to an anode purge valve to temporarily pass excess fuel flow through an anode flow path extending through the fuel cell between an anode inlet and an anode outlet, and passing the excess fuel flow through a cathode flow path of the fuel cell, the cathode flow path extending through the fuel cell between a cathode inlet and a cathode outlet;
monitoring an output voltage profile of the fuel cell during the purge cycle to determine an operational state of the purge valve.

Monitoring the fuel cell output voltage profile may comprise detecting a fuel cell voltage drop during a period following the command signal instructing opening of the anode purge valve. Monitoring the fuel cell output voltage profile may comprise detecting a fuel cell voltage rise during a period following the command signal instructing closing of the anode purge valve. A purge valve error condition may be determined if the fuel cell voltage drop fails to exceed a predetermined amount. A purge valve error condition may be determined if the fuel cell voltage rise fails to exceed a predetermined amount. The method may include shutting down hydrogen flow to the anode flow path in the event of a purge valve error condition. The method may include increasing drive current and/or voltage to the anode purge valve in the event of a purge valve failing to operate sufficiently.

The method may include recalibrating one or both of:
an opening drive current and/or voltage set point for the anode purge valve for initiating a purge cycle according to the outcome of the increased drive current and/or voltage; and
a closing drive current and/or voltage set point for the anode purge valve for ending a purge cycle according to the outcome of the increased drive voltage and/or current.

The method may include monitoring a fuel cell system temperature rise following a command signal instructing opening or closing of the anode purge valve. The method may include determining a purge valve error condition if the temperature rise exceeds a predetermined amount.

According to another aspect, the invention provides a computer program comprising computer program code means adapted, when said program is loaded onto a processing device in a fuel cell system, to make the fuel cell system execute any of the procedures as defined above.

Embodiments of the present invention will now be described by way of example and with reference to the accompanying drawings in which:

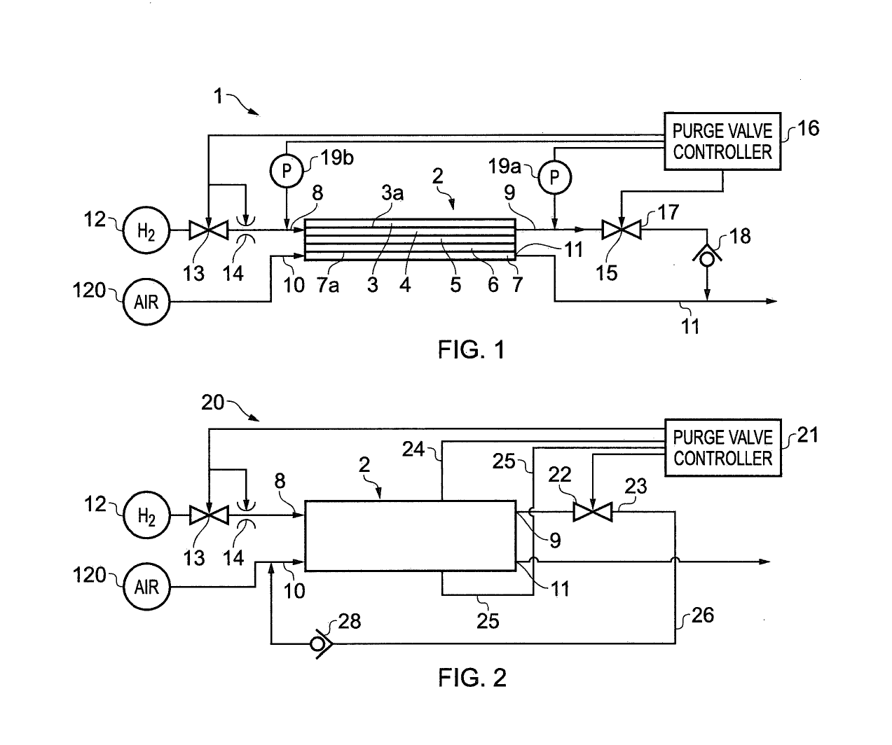

FIG. 1 shows a schematic diagram of an anode purge arrangement for a fuel cell system using a pressure sensor;

FIG. 2 shows a schematic diagram of an anode purge arrangement for a fuel cell system avoiding the necessity for use of a pressure sensor;

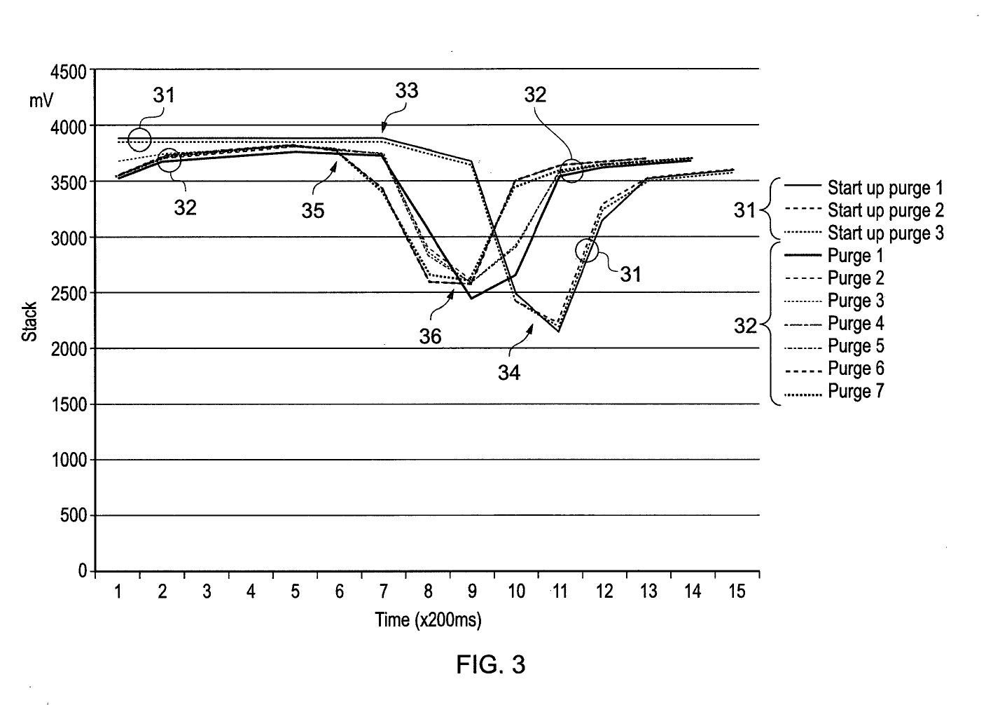

FIG. 3 shows a graph of stack voltage (in mV) as a function of time (in units of 0.2 sec) during a set of various types of anode purge cycles using the fuel cell system of FIG. 2, where the purge cycles concluded successfully;

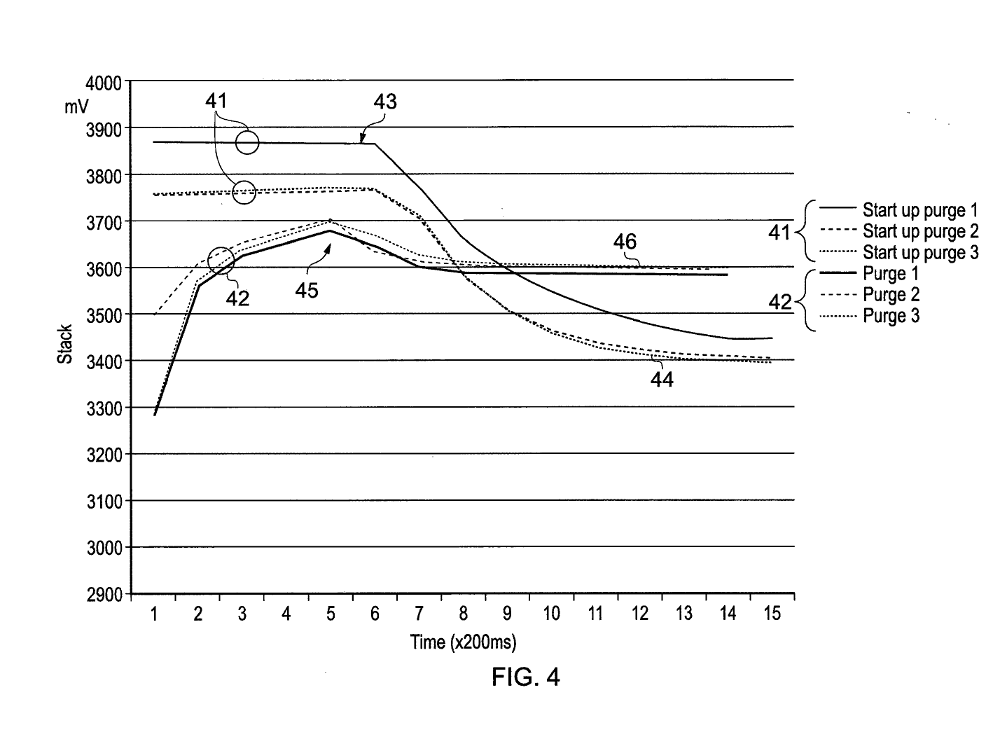

FIG. 4 shows a graph of stack voltage (in mV) as a function of time (in units of 0.2 sec) during a set of various types of anode purge cycles using the fuel cell system of FIG. 2, where the purge cycles did not conclude successfully;

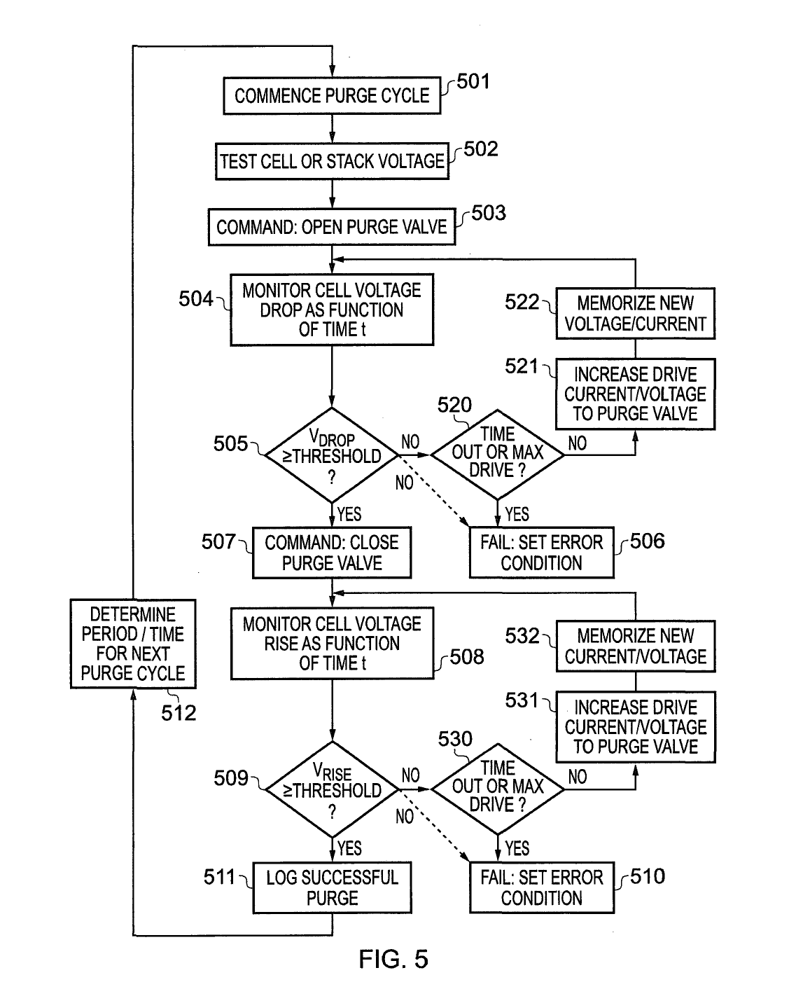

FIG. 5 shows a flowchart illustrating various control functions performed by a purge valve controller in the fuel cell system of FIG. 2;

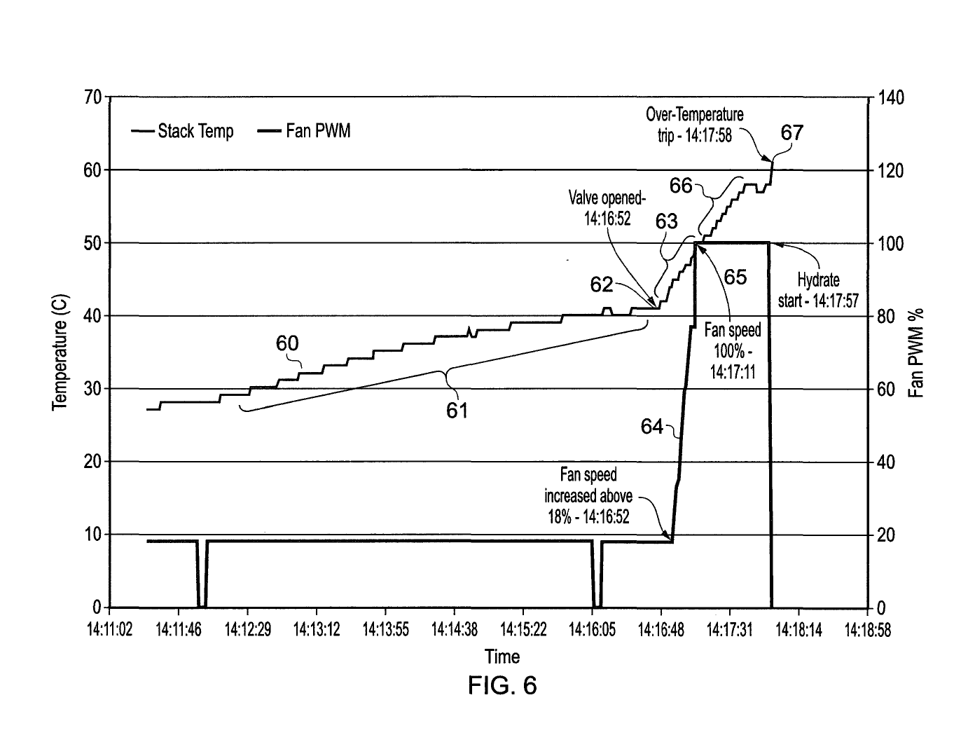

FIG. 6 shows a graph of stack temperature as a function of time indicative of purge valve failure.

With reference to FIG. 1, a fuel cell system 1 comprises a fuel cell 2 comprising an anode plate 3, an anode gas diffusion layer 4, a membrane electrode assembly 5, a cathode diffusion layer 6 and a cathode plate 7. The anode plate 3 may include fluid flow channels in a surface 3a thereof. The cathode plate 7 may include fluid flow channels in a surface 7a thereof. The anode plate 3, and any fluid flow channels therein, together with the anode gas diffusion layer 4 define an anode flow path extending through the fuel cell 2 between an anode inlet 8 and an anode outlet 9. The cathode plate 7, and any fluid flow channels therein, together with the cathode gas diffusion layer 6 define a cathode flow path extending through the fuel cell 2 between a cathode inlet 10 and a cathode outlet 11.

A fuel supply 12 (e.g. hydrogen) is coupled to the anode inlet 8 via a shut off valve 13 and a flow controller 14. An anode purge valve 15 is coupled to the anode outlet 9 and may be used to control a purge flow of hydrogen through the anode flow path, under the control of a purge valve controller 16. The anode purge valve 15 has an outlet 17 which is coupled to the cathode outlet 11 via a non-return valve 18.

An oxidant supply 120 (e.g. an air fan or blower) is coupled to the cathode inlet 10 to force ventilate the cathode flow path, the air and water/water vapour by products being exhausted from the fuel cell at the cathode outlet 11.

In a normal mode of operation, the anode purge valve 15 may be closed and the anode is pressurised from the fuel supply 12 via valve 13 and flow controller 14. The fuel flow through the anode flow path is governed by the rate of consumption of fuel at the MEA 5. Periodically, the purge valve 12 is opened to establish a purge flow through the anode flow channel. A purge flow may be considered to be a flow of fuel through the anode flow channel which exceeds the amount of fuel being consumed at the MEA. The excess flow of fuel flushes the anode flow channel and carries with it any build up of contaminants such as water/water vapour in the anode flow path to the anode outlet 9 from where it is carried to the cathode outlet 11 via the purge valve 17 and the non-return valve 18, where it is diluted with the generally much higher flows of air/oxidant passing through the cathode flow channel.

In order to verify correct operation of the purge valve 12, in the arrangement of FIG. 1, a pressure sensor/transducer 19 is used to detect that the purge valve has correctly opened and closed. The pressure sensor 19 may be disposed at the anode outlet 9 (as indicated by sensor 19a), or at the anode inlet (as indicated by sensor 19b). In one system, a purge is detected when the pressure drop is greater than 100 mbar, and similarly the closure of the purge valve 12 may be detected when the pressure returns to its pre-purge level or rises by a corresponding amount.

Building in a pressure sensor 19 adds cost and complexity to the hardware of the fuel cell system 1 and it may be advantageous to eliminate this component from the system 1.

FIG. 2 shows an alternative fuel cell system, similar to that described in connection with FIG. 1, but in which the pressure sensor 19 has been eliminated, thereby reducing cost and complexity of the system hardware.

With reference to FIG. 2, a fuel cell system 20 has a fuel cell 2, the structure of which may be similar to that described in FIG. 1 and is not repeated in detail. Only the anode inlet 8, the anode outlet 9, the cathode inlet 10 and the cathode outlet 11 are shown. A fuel supply 12 (e.g. hydrogen) is coupled to the anode inlet 8 via a shut off valve 13 and a flow controller 14. An oxidant supply 120 (e.g. an air fan or blower) is coupled to the cathode inlet 10 to force ventilate the cathode flow path. An anode purge valve 22 is coupled to the anode outlet 9 and may be used to control a purge flow of hydrogen through the anode flow path, under the control of a purge valve controller 21. The anode purge valve 22 has an outlet 23 which is coupled to the cathode inlet 10 via purge pipe 26 incorporating a non-return valve 28. The outlet 23 could incorporate a two way valve (not shown) enabling purge flow to be diverted elsewhere, if required. In general, the anode outlet 9, the anode purge valve 22, the purge pipe 26 and the non-return valve 28 may be considered to form an anode purge conduit.

In a normal mode of operation, the anode purge valve 22 may be closed and the anode is pressurised from the fuel supply 12 via valve 13 and flow controller 14. The fuel flow through the anode flow path is governed by the rate of consumption of fuel at the MEA. Periodically, the purge valve 22 is opened to establish a purge flow through the anode flow channel. A purge flow may be considered to be a flow of fuel through the anode flow channel which exceeds the amount of fuel being consumed at the MEA. The excess flow of fuel flushes the anode flow channel and carries with it any build up of contaminants such as water/water vapour in the anode flow path to the anode outlet 9 from where it is carried to the cathode inlet 10 where it is diluted with the generally much higher flows of air/oxidant passing through the cathode flow channel.

An important difference between the system of FIG. 1 and the system of FIG. 2 is that the purge gas flows which contain excess hydrogen, water, water vapour and possibly other contaminants that have built up in the anode flow channel are directed into the cathode air flows upstream of the cathode inlet 10 such that any excess hydrogen will pass into the cathode of the fuel cell. When hydrogen fuel is present at the fuel cell cathode with a small load being applied to the fuel cell then fuel cell voltage will drop in response to the presence of the hydrogen. Hydrogen present at the cathode face of the MEA of a fuel cell results in a drop in voltage and loss of efficiency of the fuel cell and a fuel cell can be highly sensitive to small quantities of hydrogen at the cathode face of the MEA. This voltage drop can be readily detected, despite the much larger volumes of air being passed through the cathode flow path.

The purge valve controller 21 is connected to cell voltage monitoring lines 24, 25 in order to monitor the profile of the cell voltage output, preferably before, during and after a purge cycle in order to verify correct operation of the purge valve 22.

In one example, normal purge flows when fed to the cathode inlet 10 while the fuel cell is subjected to a small electrical load results in a voltage drop of about 1 V whereas a similar drop under the same electrical load with no purge flow present is between 50 and 100 mV. It has therefore been recognised that it is possible to monitor correct operation of a purge valve using fuel cell voltage monitoring rather than requiring a pressure sensor.

Referring now to FIG. 3, a graph of stack voltage as a function of time is shown for two different types of purge.

Referring to voltage traces 31, at a start-up condition of a fuel cell stack (comprising a number of individual fuel cells in a stack configuration), the stack voltage was about 3.87 V. A purge cycle is initiated at point 33 by initiating opening of the purge valve 22 under the command of the purge valve controller 21. The stack voltage falls, by about 1.7 V, to 2.2 V under the electrical load applied, when the purge gas reaches the cathode flow path, over the purge cycle period of approximately 0.8 seconds. The purge cycle is ended by initiating closure of the purge valve 22 under the command of the purge valve controller 21 at point 34 on the graph. It can be seen that the stack voltage rapidly recovers to 3.6 V within about 0.8 seconds as the remaining purge gas is flushed from the cathode flow path by the normal cathode air flow.

Referring to voltage traces 32, during a periodic purge cycle during normal operation of the fuel cell stack, the stack voltage was about 3.8 V for the electrical load applied. A purge cycle is initiated at point 35 by initiating opening of the purge valve 22 under the command of the purge valve controller 21. The stack voltage falls, by about 1.2 V, to 2.6 V under the electrical load applied, when the purge gas reaches the cathode flow path, over the purge cycle period of approximately 0.6 seconds. The purge cycle is ended by initiating closure of the purge valve 22 under the command of the purge valve controller 21 at point 36 on the graph. It can be seen that the stack voltage rapidly recovers to about 3.7 V within about 0.6 seconds as the remaining purge gas is flushed from the cathode flow path by the normal cathode air flow.

Referring now to FIG. 4, a graph of stack voltage as a function of time is shown for two different types of purge where the purge pipe 26 is blocked and/or the purge valve 22 fails to open properly.

Referring to voltage traces 41, at a start-up condition of a fuel cell stack (comprising a number of individual fuel cells in a stack configuration), the stack voltage was about 3.86 V (first sample trace) or 3.76 V (second and third sample traces). A purge cycle is initiated at point 43 by initiating opening of the purge valve 22 under the command of the purge valve controller 21. The stack voltage falls only by about 0.4 V respectively to 3.45 V (first sample trace) and 3.40 V (second and third sample traces) under the electrical load applied, even after a purge time of approximately 1.2 or 1.4 seconds indicated at point 44. This is a substantially smaller drop than that caused by the full flow purge in the test illustrated in FIG. 3, and clearly indicates that the purge flow has not been adequately established.

Referring to voltage traces 42, during a periodic purge cycle during normal operation of the fuel cell stack, the stack voltage was between 3.68 and 3.70 V under the electrical load applied when a stack purge cycle was initiated at point 45. The purge cycle is initiated at point 45 by initiating opening of the purge valve 22 under the command of the purge valve controller 21. The stack voltage falls by only about 0.1 V to between 3.58 and 3.60 V under the electrical load applied, even after a purge time of 1.2 or 1.4 seconds indicated at point 46. This is a substantially smaller drop than that caused by the full flow purge in the test illustrated in FIG. 3, and clearly indicates that the purge flow has not been adequately established.

By monitoring the profile of the cell voltage or stack voltage, the purge valve controller 21 is able to assess (i) whether a purge valve 22 has opened; (ii) whether the purge valve 22 has opened fully or if there remains a blockage or obstruction in the purge pipe 26 or any other part of the purge conduit; (iii) whether the purge valve 22 recloses properly. Thus, in a general aspect, the purge valve controller 21 is configured to determine an operational state of the anode purge valve. This expression ‘operational state’ of the anode purge valve is intended to encompass the state of flow of purge gas through the valve which may be in part also affected by blockages or occlusions in any part of the purge conduit.

In an exemplary system, a change in stack voltage of less than 500 mV from a normal operating voltage of approximately 3.8 V is considered to represent a failed purge.

The purge valve controller therefore executes one or more control functions to execute and monitor purge cycles as now discussed with reference to FIG. 5.

One preferred control sequence commences a purge cycle at step 501 and tests the cell or stack voltage (step 502) to establish the baseline cell/stack voltage prior to commencement of the purge. The controller then issues a command signal to open the purge valve (step 503) and monitors the cell/stack voltage drop during a period of time following the command signal, e.g. by checking the voltage drop after a predetermined time t_{drop} (step 504). If the voltage drop ΔV_{drop} has not exceeded a threshold V_{T1} (step 505), the system may determine that an error condition exists (step 506) and may take any further action as determined by the system operation protocol.

A further preferred control sequence as illustrated in steps 507 to 510 can follow the successful detection of a purge condition in step 505. In step 507, the purge valve controller 21 issues a command signal to close the purge valve. This command may follow any suitable method for controlling/determining the duration of a purge cycle, such as a fixed time interval or according to sensed fuel cell parameters, for example. The purge valve controller 21 then monitors the cell voltage rise ΔVᵣᵢₛₑ during a period of time following the command signal 507, e.g. by checking the voltage rise after a predetermined time tᵣᵢₛₑ (step 508). If the voltage rise ΔVᵣᵢₛₑ has not exceeded a predetermined threshold V_{T2} (step 509), the system may determine that an error condition exists (step 510) and may take any further action as determined by the system operation protocol. If the voltage rise ΔVᵣᵢₛₑ has achieved the required threshold V_{T2} in step 509, the system 20 may log a successful purge operation (step 511) and then execute any suitable procedure for determine when the next purge cycle should occur (step 512).

The choice of threshold values V_{T1} and V_{T2} may be determined for specific fuel cell configurations. The choice of threshold values V_{T1} and V_{T2} may be determined for specific operating and/or load conditions on the fuel cell. The choice of threshold values V_{T1} and V_{T2} may be linked. For example, the threshold V_{T2} may be determined as a proportion of a measured value of the voltage drop ΔV_{drop} after this is checked in, for example, step 505.

The voltage drop thresholds V_{T1} and V_{T2} can be expressed as magnitudes of voltage changes or as absolute voltages if ΔV_{drop} and ΔVᵣᵢₛₑ are calculated relative to starting voltages. The fuel cell voltage drop ΔV_{drop} and the fuel cell voltage rise ΔVᵣᵢₛₑ during the respective periods can be expressed as gradients such that the thresholds to be exceeded may also be expressed as a voltage gradient achieved in certain period of time or averaged over a certain period of time.

In one preferred arrangement, the detection of an error condition (step 506 and/or step 510) may trigger the fuel cell system controller to shut off the hydrogen supply to the fuel cell anode inlet 8 by closing valve 13, or to enter a controlled shut down procedure.

The fuel cell system 20 may deploy a shape memory alloy valve as the purge control valve 21, i.e. a valve in which the actuator for opening and closing the valve relies upon the passage of current through a shape memory alloy wire (such as Nitinol) in order to shorten the wire and thereby deploy a valve closure mechanism. Such valves may require calibration to vary the current flow required through the wire in order to achieve a certain level of fluid flow through the valve. The method described above with reference to FIG. 5 may be adapted to include an automatic calibration routine as exemplified by the steps 520 to 522 and/or steps 530 to 532.

In the calibration routine, if the voltage drop tested in step 504 fails to reach the required threshold V_{T1}, the system may proceed to check that a time-out limit has not been reached (step 520) and, if not, increase the drive current and/or voltage to the purge valve 22 (step 521) and memorise that new drive current/voltage set point (step 522) before returning to the process flow at step 504, to retest for a voltage drop indicating a successful purge operation has started. This process can loop with successively increasing drive current/voltage set points until either the voltage drop threshold is achieved, or until the time out test at step 520 terminates the loop and exits to an error condition at box 506. The test at box 520 could alternatively be a test that maximum current set point has not been reached instead of a time-out test.

The new drive current/voltage set point memorised at step 522 could be reset to a low default after a preset number of purge cycles or on initialisation of the fuel cell system 20. The drive current/voltage set point memorised at step 522 could be reduced if the magnitude of voltage drop ΔV_{drop} established at steps 504, 505 is found to exceed a maximum threshold indicative of over-purging. The drive current/voltage may be increased/decreased by varying the duty cycle of a square wave drive signal or similar, or by changing the frequency of such a drive signal. The process could loop from a low drive current/voltage of, e.g. 20% of maximum, and repeatedly increment the drive current/voltage until correct operation of the purge valve is detected, or until 100% drive current has been reached.

A calibration routine similar to that defined by steps 520 to 522 could be included for the drive current required to shut off the purge valve 22. This may be applicable if the purge valve is a bistable type, requiring a current to actuate it for both the opening and closing strokes. The calibration routine exemplified in steps 530 to 532 and 510 is substantially the same as that described above with reference to steps 520 to 522 and 506 and need not be described further.

If the purge valve is a normally closed valve relying on a mechanical spring return, the calibration routine may be only applicable to the purge valve opening procedure.

In a general aspect, one or both of the calibration routines described above can be executed when the purge valve fails to operate sufficiently to allow passage of sufficient purge gas flow, or to close sufficiently to shut off purge gas flow.

A calibration routine as described above can be useful not only for initial calibration of a shape memory alloy wire actuated purge valve, but also for frequent recalibration required, e.g. because such shape memory alloy materials may change their performance over time.

The calibration routines may be used with any purge valve in which the extent of operation is a function of drive voltage and/or current flow.

FIG. 6 illustrates another safety feature to ensure that the fuel cell system can shut down hydrogen flow to the fuel cell 2 in the event that the purge valve fails to close after a purge operation. Trace 60 shows a fuel cell stack temperature profile as a function of time showing a first phase of operation 61 in which the fuel cell stack temperature steadily rises during a period of use of the fuel cell stack to deliver current. At point 62, the purge valve 22 is opened. Purge gas flowing through the purge valve 22 and into the cathode flow path will react with oxygen at the cathode thus accelerating the temperature increase, as shown in region 63 of the temperature-time profile 60. This increase may occur despite a substantially increased air flow through the cathode flow path occasioned by an increase in cathode forced ventilation indicated by a cathode ventilation fan power profile 64. If at point 65, the purge valve controller issues a command for the purge control valve to shut off, but the valve fails to close, the temperature will continue to rise indicated by temperature-time profile portion 66. At point 67, the stack temperature reaches a maximum permissible level which may be used to trigger an error condition which may cause a shut down of the stack or a closure of the hydrogen fuel valve 13. In a general aspect, the purge valve controller 21 may be configured to monitor a fuel cell system temperature rise following a command signal instructing opening or closing of the purge valve and to determine a purge valve error condition if the temperature rise exceeds a predetermined amount, e.g. if it exceeds a relative temperature rise threshold, or if it exceeds an absolute temperature level, following an opening command or a closing command.

The cell voltage monitoring by the purge valve controller as described above can be carried out on one or more individual fuel cells of a fuel cell stack, which may be selected cells in the stack, or all cells in the stack, or may be carried out on groups of cells in the stack, or may be carried out on the entire set of cells using a whole-stack voltage.

In general, the purge valve controller may operate to compare a fuel cell voltage drop ΔV_{drop} or a fuel cell voltage rise ΔVᵣᵢₛₑ with a threshold V_{T1} or V_{T2} respectively, according an expected voltage drop or rise, given prevailing operating conditions for the cell or stack. To do this, the purge valve controller 22 may be provided with one or more inputs corresponding to sensed operating conditions of the fuel cell, cells or stack. These operating conditions may include such parameters as temperature, fuel flow, electrical load, cathode output humidity, local ambient humidity, fuel cell age, atmospheric air pressure, recent operational history etc. The processor may use the inputs to determine an operating condition which can be used to determine an expected voltage drop or rise by way of an appropriate algorithm or look-up table.

The purge valve controller 21 may be a software, hardware or firmware module within the fuel cell system as a whole, or may be a software, hardware or firmware module within a system controller performing other control functions for the fuel cell system. The software may be transferrable to the fuel cell system and updatable with different control/performance parameters dependent upon the fuel cell system or on the fuel cell operating environment.

Although some illustrated arrangements above describe the sampling of cell or stack voltage levels at specific predetermined times relating to the initiation of a purge cycle by valve opening and closing commands, the voltage sampling could be continuous and the detection of voltage drops or voltage rises corresponding to purge cycle activities would be performed based on continuous monitoring of the voltage profile as a function of time, e.g. by voltage feature analysis.

Other embodiments are intentionally within the scope of the accompanying claims.

1. A fuel cell system comprising:
a fuel cell having an anode flow path extending through the fuel cell between an anode inlet and an anode outlet, and a cathode flow path extending through the fuel cell between a cathode inlet and a cathode outlet;
an anode purge valve coupled to the anode outlet, the anode purge valve having an outlet coupled to the cathode inlet; and,
a purge valve controller configured to effect a purge cycle by opening and closing the anode purge valve and to monitor a fuel cell voltage profile during the purge cycle to determine an operational state of the anode purge valve.

2. The fuel cell system of claim 1 in which the purge valve controller is configured to determine a fuel cell voltage drop during a period following a command signal instructing opening of the anode purge valve.

3. The fuel cell system of claim 1 in which the purge valve controller is configured to determine a fuel cell voltage rise during a period following a command signal instructing closing of the anode purge valve.

4. The fuel cell system of claim 2 in which the purge valve controller is configured to determine a purge valve error condition if the fuel cell voltage drop fails to exceed a predetermined amount.

5. The fuel cell system of claim 3 in which the purge valve controller is configured to determine a purge valve error condition if the fuel cell voltage rise fails to exceed a predetermined amount.

6. The fuel cell system of claim 4 in which the controller is configured to shut down hydrogen flow to the anode inlet in the event of a purge valve error condition.

7. The fuel cell system of claim 4 in which the controller is configured to increase drive voltage and/or current to the anode purge valve in the event of a purge valve failing to operate sufficiently.

8. The fuel cell system of claim 7 in which the controller is configured to recalibrate one or both of:
an opening drive voltage and/or current set point for the anode purge valve for initiating a purge cycle according to the outcome of the increased drive voltage and/or current; and
a closing drive voltage and/or current set point for the anode purge valve for ending a purge cycle according to the outcome of the increased drive voltage and/or current.

9. The fuel cell system of claim 1 in which the purge valve controller is configured to monitor a fuel cell system temperature rise following a command signal instructing opening of the anode purge valve.

10. The fuel cell system of claim 9 in which the purge valve controller is configured to determine a purge valve error condition if the temperature rise exceeds a predetermined amount.

11. The fuel cell system of claim 1 in which the purge valve controller is configured to monitor a fuel cell system temperature following a command signal instructing closing of the anode purge valve.

12. The fuel cell system of claim 11 in which the purge valve controller is configured to determine a purge valve error condition if the temperature fails to fall by a predetermined amount with a predetermined time following the command signal instructing closing of the anode purge valve.

13. A method of operating a fuel cell system comprising:
initiating a purge cycle by providing opening and closing command signals to an anode purge valve to temporarily pass excess fuel flow through an anode flow path extending through the fuel cell between an anode inlet and an anode outlet, and passing the excess fuel flow through a cathode flow path of the fuel cell, the cathode flow path extending through the fuel cell between a cathode inlet and a cathode outlet; and,
monitoring an output voltage profile of the fuel cell during the purge cycle to determine an operational state of the purge valve.

14. The method of claim 13 in which monitoring the fuel cell output voltage profile comprises detecting a fuel cell voltage drop during a period following the command signal instructing opening of the anode purge valve.

15. The method of claim 12 in which monitoring the fuel cell output voltage profile comprises detecting a fuel cell voltage rise during a period following the command signal instructing closing of the anode purge valve.

16. The method of claim 13 further including determining a purge valve error condition if the fuel cell voltage drop fails to exceed a predetermined amount.

17. The method of claim 15 further including determining a purge valve error condition if the fuel cell voltage rise fails to exceed a predetermined amount.

18. The method of claim 16 further including shutting down hydrogen flow to the anode flow path in the event of a purge valve error condition.

19. The method of claim 16 further including increasing drive current and/or voltage to the anode purge valve in the event of a purge valve failing to operate sufficiently.

20. The method of claim 19 further including recalibrating one or both of:
an opening drive current and/or voltage set point for the anode purge valve for initiating a purge cycle according to the outcome of the increased drive current and/or voltage; and
a closing drive current and/or voltage set point for the anode purge valve for ending a purge cycle according to the outcome of the increased drive voltage and/or current.

21. The method of claim 13 further including monitoring a fuel cell system temperature rise following a command signal instructing opening or closing of the anode purge valve.

22. The method of claim 21 further including determining a purge valve error condition if the temperature rise exceeds a predetermined amount.

23. (canceled)
